(19) United States
(12) Patent Application Publication
(10) Pub. No.: US 2012/0092795 A1
(43) Pub. Date: Apr. 19, 2012

(54) N-Way Power Supply Over Current Protection

(76) Inventors: Donald A. LIEBERMAN, San Jose, CA (US); Michael O'Connor, San Jose, CA (US); Raymond Bruce Wong, Santa Clara, CA (US); Kevin M. Conley, San Jose, CA (US)

(21) Appl. No.: 12/904,006

(22) Filed: Oct. 13, 2010

(51) Int. Cl. H02H 9/02

(52) U.S. Cl. 361/18

(57) ABSTRACT

A method and apparatus for managing over current protection in a power supply unit is disclosed. One aspect of certain embodiments includes comparing for each conductor of a plurality of conductors the current flowing through the particular conductor with over current protection limit associated with that particular conductor.

### CROSS REFERENCE TO RELATED APPLICATIONS

This application is related to U.S. application Ser. No. 12/904,029 filed Oct. 13, 2010 entitled “N-Way Power Supply Over Current Protection.”

### TECHNICAL FIELD

The disclosed embodiments relate generally to power supply units. More particularly, the disclosed embodiments relate to methods and apparatus for managing over current protection in a power supply.

### BACKGROUND

Power supply units (PSU) need to be able to supply various voltages for proper operation of the computers. Specifically, the power requirements of high end computers require power supply units to source 1000 watts or 1200 watts. For example, a pair of 12 Volt DC-DC converters in a PSU can source such power requirements. The output of each of the converters are wire ORed to form a single voltage output to supply current required by the computer motherboard and peripherals. In other words, such a single voltage output supplies the required current to multiple connectors associated with the mother board and peripherals. There is a sense resistor, for example, connected in series to the single voltage output. Usually, each connector has a limited ability to carry much more than 20 to 30 amps of current due to limitations in contact and wire resistance. An over current protection circuit monitors the voltage drop across the single sense resistor to prevent current of over 100 amps from flowing through any one of the multiple connectors. However, such an implementation is incapable of distinguishing an acceptable condition of outputting 100 amps through the single voltage output to be distributed amongst 4 connectors of 25 amps each, for example, from an unacceptable condition of outputting 100 amps destined for a single connector. Thus, another method of managing over current protection is needed.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating logical components of a power supply unit (PSU) for supplying current to computers, according to certain embodiments.

FIG. 2 is a block diagram illustrating logical components of a power supply unit (PSU) for supplying current to computers and is similar to FIG. 1, according to certain embodiments.

FIG. 3 is a block diagram illustrating logical components including clusters of conductors of a power supply unit (PSU) for supplying current to computers, according to certain embodiments.

FIG. 4 is a high-level flow chart showing some of the steps for managing over current protection in a power supply unit for use with a computer.

FIG. 5 is another high-level flow chart showing some of the steps for managing over current protection in a power supply unit for use with a computer.

### DESCRIPTION OF EMBODIMENTS

Methods, systems, apparatus, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

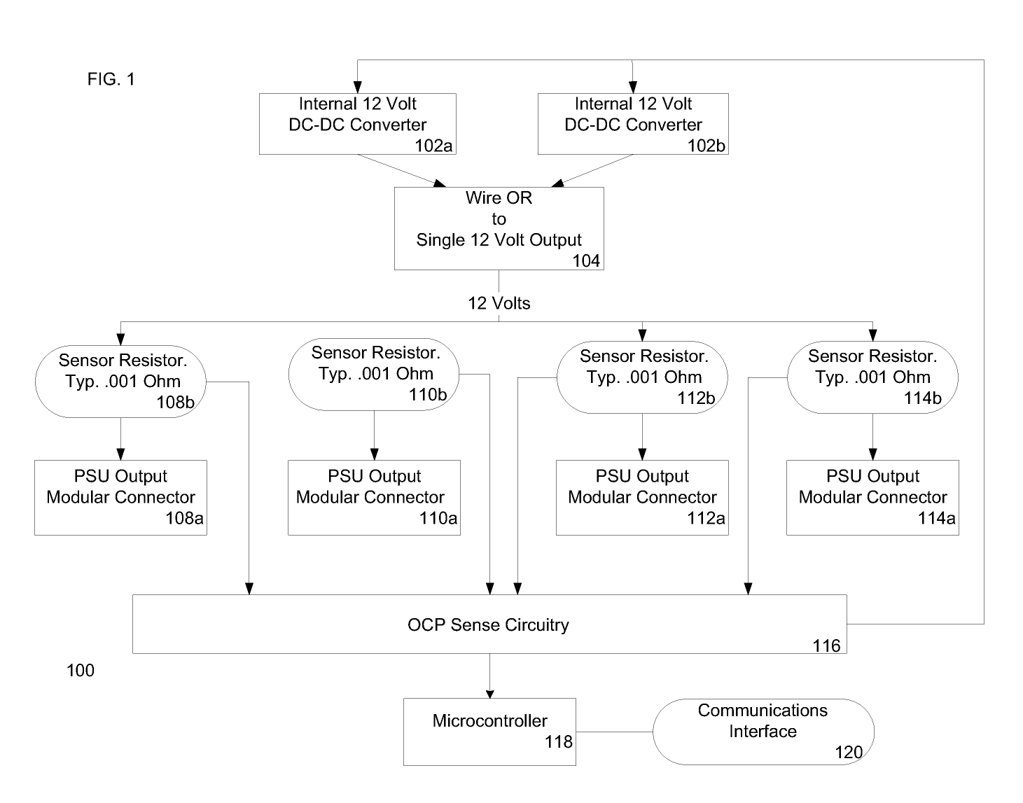

FIG. 1 is a block diagram illustrating logical components of a power supply unit (PSU) for supplying current to computers, according to certain embodiments. In FIG. 1, power supply unit 100 may include one or more 12 Volt DC to DC converters such as DC to DC converters 102a and 102b, for example. FIG. 1 shows only 2 DC to DC converters but the embodiments are not restricted to two DC to DC converters. In FIG. 1, the output of the 12 Volt DC to DC converters 102a and 102b are wire ORed to form a single voltage output 104 to supply current to a computer through the output connectors 108a, 110a, 112a, 114a of the PSU, according to certain embodiments. The embodiments are not restricted to the number of output connectors shown in FIG. 1. However, according to certain embodiments the PSU has at least two connectors. There are at least two conductors in each connector (one voltage supply conductor and one ground conductor), according to certain embodiments.

According to certain embodiments, a mechanism for measuring the current that is to flow to each individual connector can be used. For example, a sense resistor may be connected in series with each of the connectors 108a, 110a, 112a, 114a. FIG. 1 shows sense resistors 108b, 110b, 112b, 114b connected in series with the corresponding connectors 108a, 110a, 112a, 114a. The embodiments are not restricted to a one-to-one correspondence between the current measuring mechanism and the connector. A given current measuring mechanism may be connected to more than one connector of the PSU. For example, in FIG. 1 there may be only three sense resistors 108b, 112b and 114b instead of four sense resistors. As an example, sense resistor 108b may be connected to connectors 108a and 110a while sense resistor 112b is connected to connector 112a and sense resistor 114b is connected to connector 114a.

According to certain embodiments, an over current protection (OCP) mechanism such as OCP sense circuitry 116 can monitor the voltage drop across each current measuring mechanism such as sense resistors 108b, 110b, 112b, 114b of FIG. 1. OCP sense circuitry 116 compares the measured current for a given connector with the OCP limit programmed for that particular connector. Different over current protection limits may be individually set for each connector. For example, one of the connectors may have a programmed limit of a few milliamps, while another connector may have a programmed limit of 75 amps. According to certain embodiments, a microcontroller such as microcontroller 118 may be used to program individual over current protection limits using a communications interface 120. According to other embodiments, a plurality of potentiometers may be used to program the individual over current protection limits. If any of the programmed over current protection limits are exceeded, then the OCP sense circuitry 116 disables the voltage output sources in the PSU, according to certain embodiments.

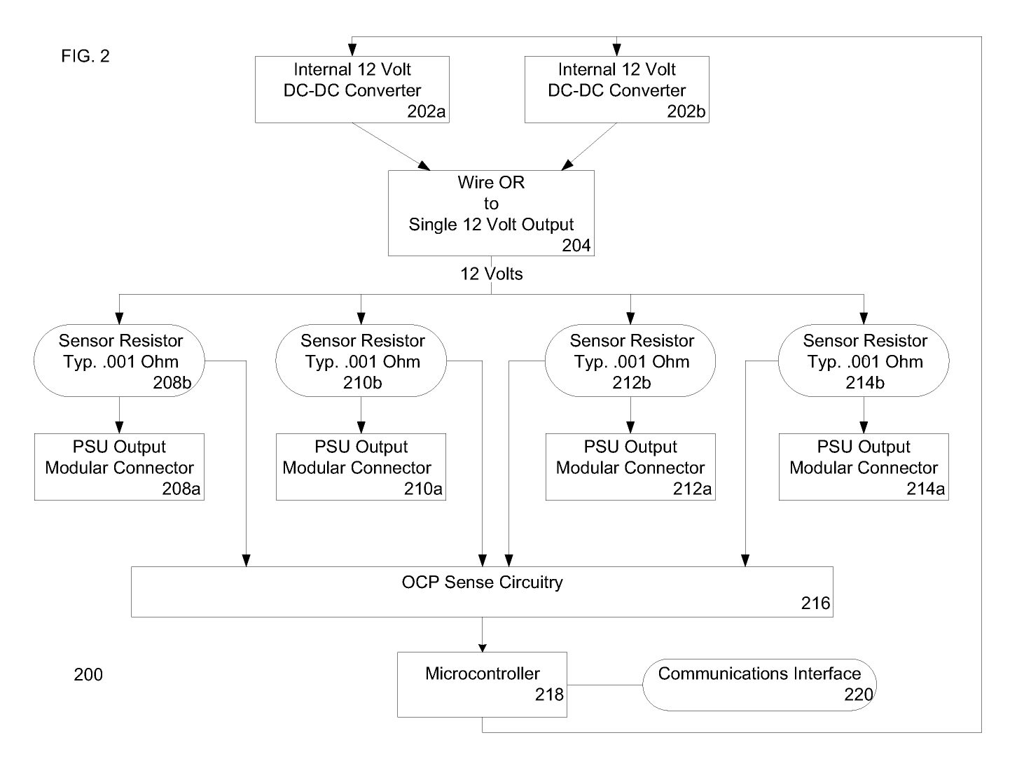

FIG. 2 is a block diagram illustrating logical components of a power supply unit (PSU) for supplying current to computers and is similar to FIG. 1, according to certain embodiments. The difference between FIG. 2 and FIG. 1 is that the microcontroller 218 in FIG. 2 is capable of disabling the voltage output sources in the PSU if any of the programmed over current protection limits are exceeded, according to certain embodiments.

In FIG. 2, power supply unit 200 may include one or more 12 Volt DC to DC converters such as DC to DC converters 202a and 202b, for example. FIG. 2 shows only 2 DC to DC converters but the embodiments are not restricted to two DC to DC converters. In FIG. 2, the output of the 12 Volt DC to DC converters 202a and 202b are wire ORed to form a single voltage output 204 to supply current to a computer through the output connectors 208a, 210a, 212a, 214a of the PSU, according to certain embodiments. The embodiments are not restricted to the number of output connectors shown in FIG. 2. However, according to certain embodiments the PSU has at least two connectors. There are at least two conductors in each connector (one voltage supply conductor and one ground conductor), according to certain embodiments.

According to certain embodiments, a mechanism for measuring the current that is to flow to each individual connector can be used. For example, a sense resistor may be connected in series with each of the connectors 208a, 210a, 212a, 214a. FIG. 2 shows sense resistors 208b, 210b, 212b, 214b connected in series with the corresponding connectors 208a, 210a, 212a, 214a. The embodiments are not restricted to a one-to-one correspondence between the current measuring mechanism and the connector. A given current measuring mechanism may be connected to more than one connector of the PSU. For example, in FIG. 2 there may be only three sense resistors 208b, 212b and 214b instead of four sense resistors. As an example, sense resistor 208b may be connected to connectors 208a and 210a while sense resistor 212b is connected to connector 212a and sense resistor 214b is connected to connector 214a.

According to certain embodiments, an over current protection (OCP) mechanism such as OCP sense circuitry 216 can monitor the voltage drop across each current measuring mechanism such as sense resistors 208b, 210b, 212b, 214b of FIG. 2. OCP sense circuitry 216 compares the measured current for a given connector with the OCP limit programmed for that particular connector. Different over current protection limits may be individually set for each connector. For example, one of the connectors may have a programmed limit of a few milliamps, while another connector may have a programmed limit of 75 amps. According to certain embodiments, a microcontroller such as microcontroller 218 may be used to program individual over current protection limits using a communications interface 220. According to other embodiments, a plurality of potentiometers may be used to program the individual over current protection limits. If any of the programmed over current protection limits are exceeded, then the microcontroller 218 disables the voltage output sources in the PSU, according to certain embodiments.

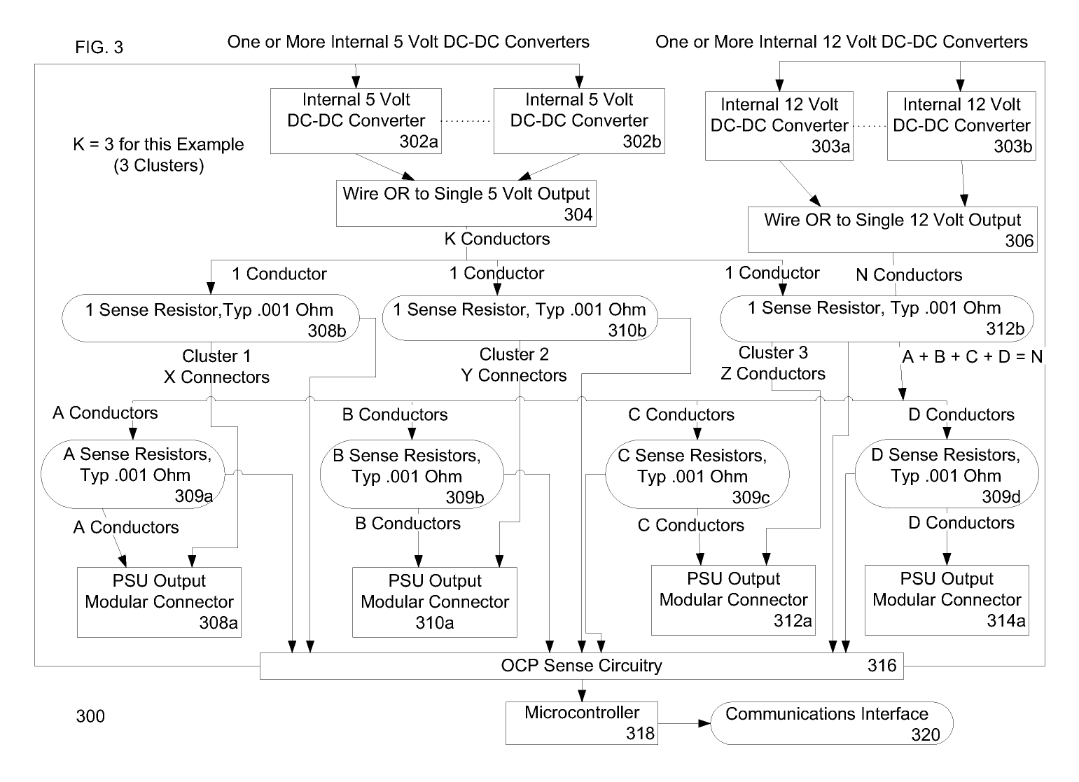

FIG. 3 is a block diagram illustrating logical components including clusters of conductors of a power supply unit (PSU) for supplying current to computers, according to certain embodiments.

In FIG. 3, power supply unit 300 may include one or more 12 Volt DC to DC converters such as DC to DC converters 303a and 303b, for example. FIG. 3 shows only 2 12 volt DC to DC converters but the embodiments are not restricted to two 12 volt DC to DC converters. In FIG. 3, the output of the 12 Volt DC to DC converters 303a and 303b are wire ORed to form a single voltage output 306 to supply current to a computer through N voltage supply conductors, where N is greater than or equal to 2 (A+B+C+D=N). In FIG. 3, quantity A conductors of the N voltage supply conductors are connected to the output connectors 308a of the PSU, according to certain embodiments. Quantity B conductors of the N voltage supply conductors are connected to the output connectors 310a of the PSU. Quantity C conductors of the N voltage supply conductors are connected to the output connectors 312a of the PSU. Quantity D conductors of the N voltage supply conductors are connected to the output connectors 314a of the PSU. The embodiments are not restricted to the number of output connectors shown in FIG. 3.

According to certain embodiments, a mechanism for measuring the current that is to flow through each individual conductor can be used. For example, quantity A sense resistors 309a may be connected in series with quantity A conductors. Similarly, quantity B sense resistors 309b may be connected in series with quantity B conductors. Quantity C sense resistors 309c may be connected in series with quantity C conductors. Quantity D sense resistors 309d may be connected in series with quantity D conductors.

According to certain embodiments, an over current protection (OCP) mechanism such as OCP sense circuitry 316 can monitor the voltage drop across each current measuring mechanism such as sense resistors 309a, 309b, 309c, 309d of FIG. 3. OCP sense circuitry 316 compares the measured current for a given conductor (Quantity A, B or C conductors, for example) with the OCP limit programmed for that particular conductor. Different over current protection limits may be individually set for each conductor. For example, one of the conductors may have a programmed limit of a few milliamps, while another conductor may have a programmed limit of 75 amps. According to certain embodiments, a microcontroller such as microcontroller 318 may be used to program individual over current protection limits using a communications interface 320. According to other embodiments, a plurality of potentiometers may be used to program the individual over current protection limits. If any of the programmed over current protection limits are exceeded, then the OCP sense circuitry 316 disables the voltage output sources in the PSU, according to certain embodiments.

In FIG. 3, power supply unit 300 may include one or more 5 Volt DC to DC converters such as DC to DC converters 302a and 302b, for example. FIG. 3 shows only 2 5 volt DC to DC converters but the embodiments are not restricted to two 5 volt DC to DC converters. In FIG. 3, the output of the 5 Volt DC to DC converters 302a and 302b are wire ORed to form a single voltage output 304 to supply current to a computer through K voltage supply conductors where K is greater than or equal to 1 (for example, K=3) and corresponding output connectors 308a, 310a, 312a, 314a of the PSU, according to certain embodiments. According to certain embodiments, one conductor of the K voltage supply conductors can form cluster 1 of X voltage supply conductors. Similarly, another conductor of the K voltage supply conductors can form cluster 2 of Y voltage supply conductors and yet another conductor of the K voltage supply conductors can form cluster 3 of Z voltage supply conductors. Note that Conductors 1, 2 and 3 of the K voltage supply conductors are split into the Clusters 1, 2 and 3 respectively, after the sense resistors measure the current flowing through the corresponding conductor.

According to certain embodiments, a current measuring mechanism such as a sense resistor can be used to measure current that is to flow through each of the K voltage supply conductors and corresponding output connectors. FIG. 3 shows sense resistors 308b, 310b, and 312b connected in series to voltage supply conductors 1, 2 and 3 of the K voltage supply conductors respectively and their corresponding output connectors.

Over current protection (OCP) mechanism such as OCP sense circuitry 316 can monitor the voltage drop across sense resistors 308b, 310b, and 312b of FIG. 3. OCP sense circuitry 316 compares the measured current for a given Kth conductor (K=1, 2 or 3) with the OCP limit programmed for that particular conductor. Different over current protection limits may be individually set for each of the voltage supply K conductors. According to some embodiments, a plurality of potentiometers may be used to program the individual over current protection limits. If any of the programmed over current protection limits are exceeded, then the OCP sense circuitry 316 disables the voltage output sources in the PSU, according to certain embodiments.

According to certain embodiments, the function of measuring current that is to flow through a given connector and the function of comparing the measured current for the given connector with the OCP limit programmed for that particular connector can be implemented by one device. In other embodiments such functions may be implemented by separate devices.

According to certain embodiments, microcontrollers, digital signal processing (DSP) chips, and analog circuits may be used alone or in combination to perform one or more of the following tasks:
programming an individual over current protection limit corresponding to each of the voltage supply conductors or connectors, wherein each individual over current protection limit is programmed independently of the other over current protection limits;
measuring the individual current flowing through the individual voltage supply conductor or connector;
comparing the measured individual current flowing through the individual voltage supply conductor or connector with the associated over current protection limit corresponding to that individual conductor or connector; and
disabling the single voltage output source either directly or indirectly.

In some embodiments, the microcontroller, the DSP chip and analog circuit may each be associated with a communications interface for programming OCP limits for the individual connectors.

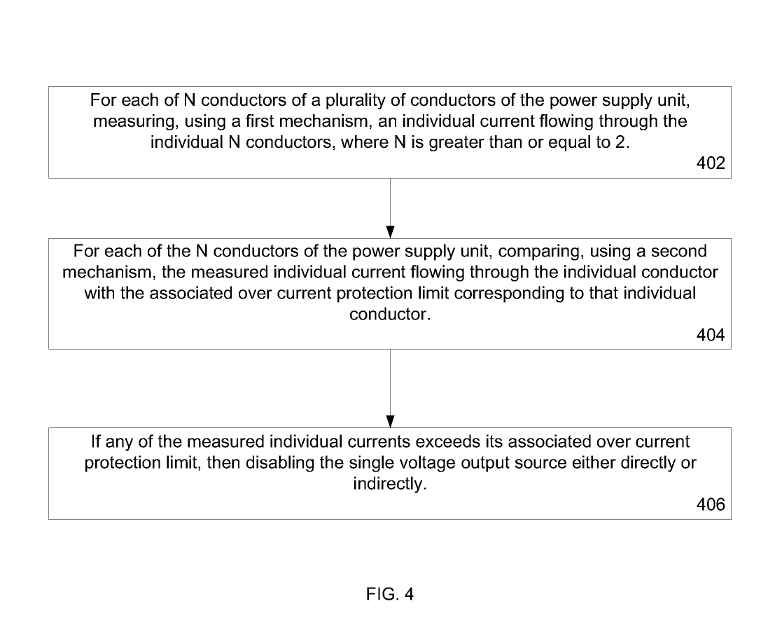

FIG. 4 is a high-level flow chart showing some of the steps for managing over current protection in a power supply unit for use with a computer. At block 402, for each of N voltage supply conductors of a plurality of conductors of the power supply unit, measuring, using a first mechanism, an individual current flowing through the individual N voltage supply conductors, where N is greater than or equal to 2. The individual currents corresponding to the N individual conductors are from a single voltage output source of one or more voltage sources of the power supply unit. Each individual conductor is associated with an over current protection limit that is independent of the over current protection limits of the other conductors. At block 404, for each of the N voltage supply conductors of the power supply unit, comparing, using a second mechanism, the measured individual current flowing through the individual conductor with the associated over current protection limit corresponding to that individual conductor. At block 406, if any of the measured individual currents exceeds its associated over current protection limit, then disabling the single voltage output source either directly or indirectly.

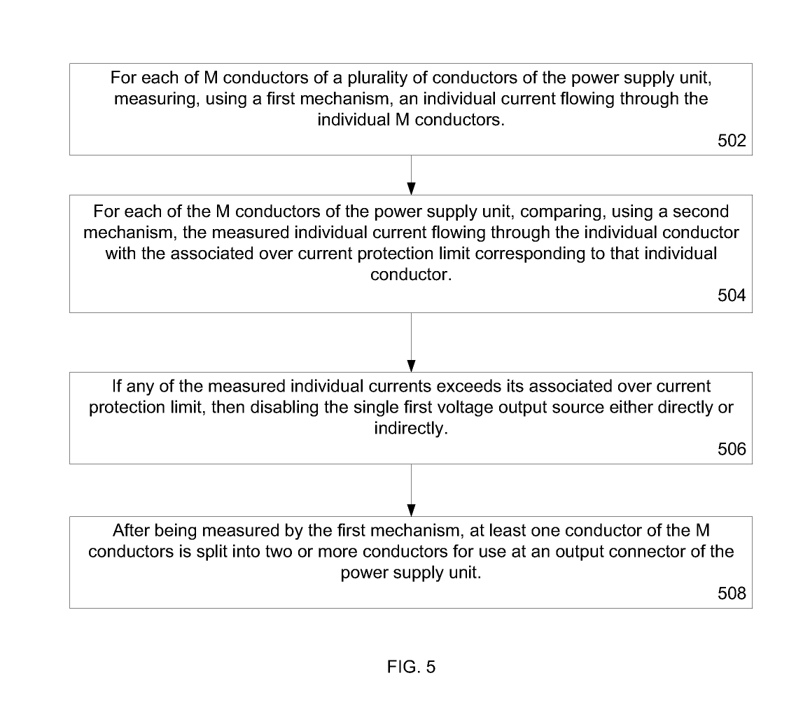

FIG. 5 is another high-level flow chart showing some of the steps for managing over current protection in a power supply unit for use with a computer. At block 502, for each of M voltage supply conductors of a plurality of conductors of the power supply unit, measuring, using a first mechanism, an individual current flowing through the individual M voltage supply conductors. M is a positive integer greater than or equal to 1. The individual currents corresponding to the M individual conductors are from a single first voltage output source of one or more voltage sources of the power supply unit. Each individual conductor is associated with an over current protection limit that is independent of the over current protection limits of the other conductors. At block 504, for each of the M voltage supply conductors of the power supply unit, comparing, using a second mechanism, the measured individual current flowing through the individual conductor with the associated over current protection limit corresponding to that individual conductor. At block 506, if any of the measured individual currents exceeds its associated over current protection limit, then disabling the single first voltage output source either directly or indirectly. At block 508, after being measured by the first mechanism, at least one conductor of the M voltage supply conductors is split into two or more conductors for use at an output connector of the power supply unit.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We Claim:

1. A method of managing over current protection in a power supply unit for use with a computer, the method comprising:
for each of N voltage supply conductors of a plurality of conductors of the power supply unit, measuring, using a first mechanism, an individual current flowing through the individual N voltage supply conductors,
wherein:
the individual currents corresponding to the N individual conductors are from a single first voltage output source of one or more voltage sources of the power supply unit;
each individual conductor is associated with an over current protection limit that is independent of the over current protection limits of the other conductors; and
N is a positive integer greater than or equal to 2;
for each of the N voltage supply conductors of the power supply unit, comparing, using a second mechanism, the measured individual current flowing through the individual conductor with the associated over current protection limit corresponding to that individual conductor; and
if any of the measured individual currents exceeds its associated over current protection limit, then disabling the single first voltage output source either directly or indirectly.

2. The method of claim 1, wherein the first mechanism includes N current detectors that are connected in series with the N voltage supply conductors, each current detector being associated with one conductor and for measuring an individual current flowing through its associated conductor.

3. The method of claim 1, further comprising:
for each of M voltage supply conductors of the plurality of conductors of the power supply unit, measuring, using the first mechanism, an individual current flowing through the individual M voltage supply conductors,
wherein:
the individual currents corresponding to the M individual conductors are from a single second voltage output source of one or more voltage sources of the power supply unit;
each of the individual M voltage supply conductors is associated with an over current protection limit that is independent of the over current protection limits of the other conductors; and
M is a positive integer greater than or equal to 1;
for each of the M voltage supply conductors of the power supply unit, comparing, using a second mechanism, the measured individual current flowing through the individual conductor with the associated over current protection limit corresponding to that individual conductor; and
if any of the measured individual currents exceeds its associated over current protection limit, then disabling the single second voltage output source either directly or indirectly.

4. The method of claim 3, wherein the first mechanism includes M current detectors that are connected in series with the M voltage supply conductors, each current detector being associated with one conductor and for measuring an individual current flowing through its associated conductor.

5. The method of claim 3, wherein after being measured by the first mechanism, at least one conductor of the M voltage supply conductors is split into two or more conductors for use at an output connector of the power supply unit.

6. The method of claim 1, further comprising setting each over current protection limit independently from the other over current protection limits associated with the other conductors.

7. The method of claim 1, wherein the first mechanism and the second mechanism are implemented in one device.

8. The method of claim 1, wherein the first mechanism and the second mechanism are implemented in separate devices.

9. The method of claim 3, further comprising setting each over current protection limit independently from the other over current protection limits associated with the other conductors.

10. The method of claim 3, wherein the first mechanism and the second mechanism are implemented in one device.

11. The method of claim 3, wherein the first mechanism and the second mechanism are implemented in separate devices.

12. The method of claim 1, further comprising using a microcontroller for one or more of a set consisting of:
programming an individual over current protection limit corresponding to each of the N voltage supply conductors, wherein each individual over current protection limit is programmed independently of the other over current protection limits;
measuring the individual current flowing through the individual N voltage supply conductors;
comparing the measured individual current flowing through the individual conductor with the associated over current protection limit corresponding to that individual conductor; and
disabling the single first voltage output source either directly or indirectly.

13. The method of claim 1, further comprising using a Digital Signal Processing chip for one or more of a set consisting of:
programming an individual over current protection limit corresponding to each of the N voltage supply conductors, wherein each individual over current protection limit is programmed independently of the other over current protection limits;
measuring the individual current flowing through the individual N voltage supply conductors;
comparing the measured individual current flowing through the individual conductor with the associated over current protection limit corresponding to that individual conductor; and
disabling the single first voltage output source either directly or indirectly.

14. The method of claim 1, further comprising using an analog control circuit for one or more of a set consisting of:
programming an individual over current protection limit corresponding to each of the N voltage supply conductors, wherein each individual over current protection limit is programmed independently of the other over current protection limits;
measuring the individual current flowing through the individual N voltage supply conductors;
comparing the measured individual current flowing through the individual conductor with the associated over current protection limit corresponding to that individual conductor; and
disabling the single first voltage output source either directly or indirectly

15. The method of claim 1, further comprising using a plurality of potentiometers for programming an individual over current protection limit corresponding to each of the N voltage supply conductors, wherein each individual over current protection limit is programmed independently of the other over current protection limits.

16. The method of claim 12, wherein the microcontroller is associated with a user interface for allowing a user to program the individual over current protection limit corresponding to each of the N voltage supply conductors.

17. The method of claim 13, wherein the Digital Signal Processing is associated with a user interface for allowing a user to program the individual over current protection limit corresponding to each of the N voltage supply conductors.

18. The method of claim 14, wherein the analog control circuit is associated with a user interface for allowing a user to program the individual over current protection limit corresponding to each of the N voltage supply conductors.

19. The method of claim 3, further comprising using a microcontroller for one or more of a set consisting of:
programming an individual over current protection limit corresponding to each of the M voltage supply conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single second voltage output source either directly or indirectly.

20. The method of claim 3, further comprising using a Digital Signal Processing chip for one or more of a set consisting of:
programming an individual over current protection limit corresponding to each of the M conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single second voltage output source either directly or indirectly.

21. The method of claim 3, further comprising using an analog control circuit for one or more of a set consisting of:
programming an individual over current protection limit corresponding to each of the M voltage supply conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single second voltage output source either directly or indirectly.

22. The method of claim 3, further comprising using a plurality of potentiometers for programming an individual over current protection limit corresponding to each of the M voltage supply conductors, wherein each individual over current protection limit is programmed independently of the other over current protection limits.

23. The method of claim 19, wherein the microcontroller is associated with a user interface for allowing a user to program the individual over current protection limit corresponding to each of the M voltage supply conductors.

24. The method of claim 20, wherein the Digital Signal Processing is associated with a user interface for allowing a user to program the individual over current protection limit corresponding to each of the M voltage supply conductors.

25. The method of claim 21, wherein the analog control circuit is associated with a user interface for allowing a user to program the individual over current protection limit corresponding to each of the M voltage supply conductors.

26. A method of managing over current protection in a power supply unit for use with a computer, the method comprising:
for each of M voltage supply conductors of a plurality of conductors of the power supply unit, measuring, using a first mechanism, an individual current flowing through the individual M voltage supply conductors,
wherein:
the individual currents corresponding to the M individual conductors are from a single first voltage output source of one or more voltage sources of the power supply unit;
each individual conductor is associated with an over current protection limit that is independent of the over current protection limits of the other conductors; and
M is a positive integer greater than or equal to 1;
for each of the M voltage supply conductors of the power supply unit, comparing, using a second mechanism, the measured individual current flowing through the individual conductor with the associated over current protection limit corresponding to that individual conductor;
if any of the measured individual currents exceeds its associated over current protection limit, then disabling the single first voltage output source either directly or indirectly; and
wherein after being measured by the first mechanism, at least one conductor of the M voltage supply conductors is split into two or more conductors for use at an output connector of the power supply unit.

27. Method of claim 26, wherein the first mechanism includes M current detectors that are connected in series with the M voltage supply conductors, each current detector being associated with one conductor and for measuring an individual current flowing through its associated conductor.

28. The method of claim 26, wherein the output connector of the power supply unit is an output modular connector.

29. The method of claim 26, further comprising setting each over current protection limit independently from the other over current protection limits associated with the other conductors.

30. The method of claim 26, wherein the first mechanism and the second mechanism are implemented in one device.

31. The method of claim 26, wherein the first mechanism and the second mechanism are implemented in separate devices.

32. The method of claim 26, further comprising using a microcontroller for one or more of a set consisting of:
programming an individual over current protection limit corresponding to each of the M voltage supply conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single first voltage output source either directly or indirectly.

33. The method of claim 26, further comprising using a Digital Signal Processing chip for one or more of a set consisting of:
programming an individual over current protection limit corresponding to each of the M voltage supply conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single first voltage output source either directly or indirectly.

34. The method of claim 26, further comprising using an analog control circuit for one or more of a set consisting of:
programming an individual over current protection limit corresponding to each of the M voltage supply conductors, wherein each individual over current protection limit is programmed independently of the other over current protection limits;
measuring the individual current flowing through the individual M voltage supply conductors;
comparing the measured individual current flowing through the individual conductor with the associated over current protection limit corresponding to that individual conductor; and
disabling the single first voltage output source either directly or indirectly.

35. The method of claim 26, further comprising using a plurality of potentiometers for programming an individual over current protection limit corresponding to each of the M voltage supply conductors, wherein each individual over current protection limit is programmed independently of the other over current protection limits.

36. The method of claim 32, wherein the microcontroller is associated with a user interface for allowing a user to program the individual over current protection limit corresponding to each of the M voltage supply conductors.

37. The method of claim 33, wherein the Digital Signal Processing is associated with a user interface for allowing a user to program the individual over current protection limit corresponding to each of the M voltage supply conductors.

38. The method of claim 34, wherein the analog control circuit is associated with a user interface for allowing a user to program the individual over current protection limit corresponding to each of the M voltage supply conductors.
